(19) United States
(12) Patent Application Publication
(10) Pub. No.: US 2006/0091854 A1
(43) Pub. Date: May 4, 2006

(54) Power monitoring and balancing device

(76) Inventors: Yi-Chang Chen, Taipei (TW); Kuo-Yuan Yuan, Taipei (TW)

Correspondence Address: Yi-Wen Tseng, 4331 Stevens Battle Lane, Fairfax, VA, 22033, US

(21) Appl. No.: 10/975,547

(22) Filed: Oct. 29, 2004

(51) Int. Cl. H02J 7/00

(52) U.S. Cl. 320/116

(57) ABSTRACT

A power monitoring and balancing device for a battery has a power monitoring unit, a storing unit with a plurality of cells and a balancing unit. An analog-to-digital converter formed in the power monitoring unit detects each voltage of cells timely and transmits detected result to a micro controller unit to determine whether each voltage is the same or some are higher than others. If there exits different voltage, the balancing unit connected between that cell and the power monitoring unit will discharge a small amount current of the cell with higher voltage to make every cell maintain the same voltage for facilitating the battery fill with or exhaust electric power equally.

### BACKGROUND OF THE INVENTION

The present invention relates in general to a power monitoring and balancing device, and more particularly, to a power monitoring and balancing device for a battery with multiple cells connected in series, which is utilized to detect electric energy status of the cells and to balance voltages of each cell in order to make each cell be charged or discharged equally.

Nowadays a computer becomes a daily use in almost every house. The computer can help people to do a lot of things and is playing an important role in the modern life. Some people usually work or speak outside, a laptop computer is more convenient. The laptop computer utilizes an adapter connected to a plug for receiving power. When users take the laptop computer outside, the laptop computer can be powered by a rechargeable battery.

With reference to FIG. 1, a conventional rechargeable battery with a plurality of cells connected in series contains a rechargeable circuit and a protecting and detecting circuit. The protecting and detecting circuit comprises a protecting unit and a power monitoring unit. The power monitoring unit communicates with the laptop computer to measure voltage, current and temperature of the battery, and determines the residual electricity of the battery to let users know when the battery needed to be recharged.

The protecting unit timely detects the voltage and current of the battery. If only one cell with sufficient lower voltage is detected, the protecting unit will stop to supply power to all cells. Then, all cells are charged until the cell with higher voltage is finished charging; however, the cell with lower voltage is still not charged enough. In other words, not all the cells can be charged to have a predetermined amount of electrical energy.

The U.S. Pat. No. 5,886,502 disclosed a cell balance circuit which utilizes a voltage converting circuit and a lowest voltage output circuit for comparing each residual voltage of the cells to achieve a cell balance control. Although the method can achieve the cell balance control, the circuit design is complicate and is not easy for manufacturing and has high cost.

### BRIEF SUMMARY OF THE INVENTION

The present invention provides a power monitoring and balancing device for a battery with a plurality of cells connected in series, which utilizes an original internal circuit of a power monitoring unit added a simple balancing unit in order to let every cell of the battery maintain same voltage and fill with electricity when electrified for increasing a life-span of the battery.

Accordingly, the power monitoring and balancing device for a battery provided power to an electronic device of the present invention comprises a storing unit, a power monitoring, a plurality of balancing units, a regulator, and a voltage divider. The storing unit comprises a plurality of cells. The power monitoring unit is connected with the storing unit comprising transmitting ends communicating with the electronic device. Each balancing unit is connected between one cell and the power monitoring unit. The regulator is connected between the storing unit and the power monitoring unit. The voltage divider is connected between the storing unit and the power monitoring unit. Whereby the power monitoring unit detects and determines each voltage of the cells and then switches on a balancing unit that controls a cell with higher than other cells such that the cell is discharged until every cell has same voltage, and the regulator and the voltage divider respectively regulate and divide an input voltage receiving by the power monitoring unit within a working voltage range of the power monitoring unit.

The objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These as well as other features of the present invention will become more apparent upon reference to the drawings therein:

FIG. 1 is a circuit diagram of a conventional battery with a power monitoring device for a laptop computer.

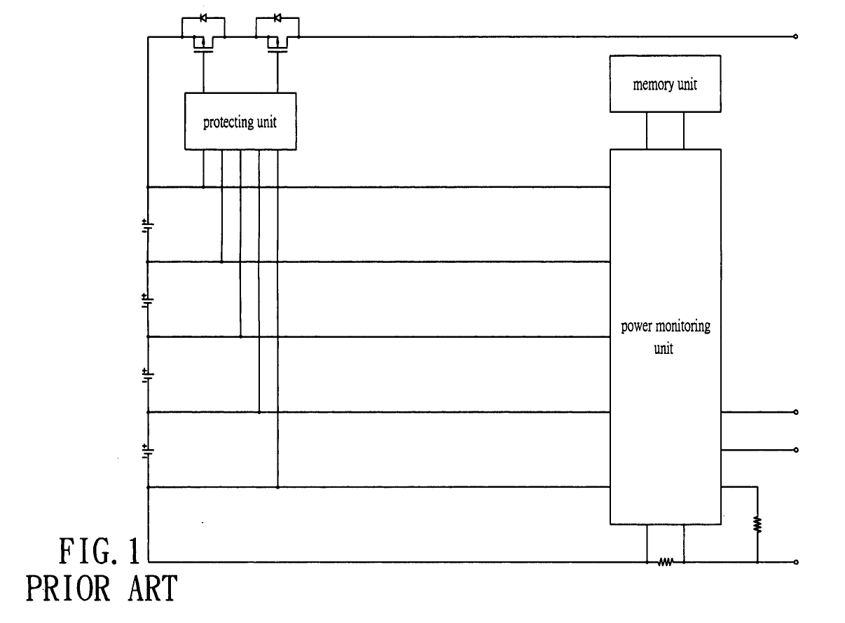

FIG. 2 is a circuit diagram of a power monitoring and balancing device in accordance with the present invention.

FIG. 3 is an operative view of the power monitoring and balancing device of FIG. 2.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

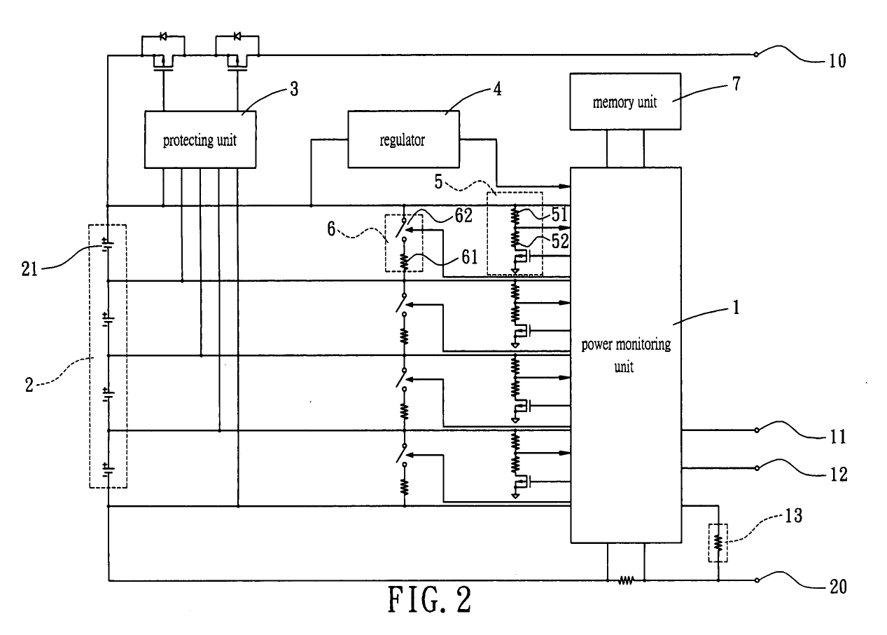

Referring to FIG. 2, a power monitoring and balancing device for a battery in accordance with the present invention, which is utilized in an electronic device, comprises a power monitoring unit 1, a storing unit 2 comprising at least one cell 21, a protecting unit 3, at least one regulator 4, at least one voltage divider 5, at least one balancing unit 6 and a memory unit 7. The balancing unit 6 makes each cell 21 of the storing unit 2 maintain the same voltage in order to fill with or exhaust electricity equally of each cell 21 when the cell 21 is charged or discharged.

The power monitoring unit 1 comprises a micro controller unit (MCU) and two analog-to-digital converters (ADC). The power monitoring unit 1 is utilized for measuring voltage and electric current of the storing unit 2, via system management bus (SMBUS) control to transmit SMB CLK and SMB DATA signals from two transmitting ends 11, 12 to an electronic device (ex. laptop computer or PDA) so that the electronic device can know a present status of the storing unit 2. At the same time, the power monitoring unit 1 connects to a temperature detecting unit 13 utilized for detecting temperature and transmitting the detecting result through the transmitting end 12 to the electronic device.

The storing unit 2 connects to the power monitoring unit 1 and is preferably composed of general rechargeable cells for storing electric power to the electronic device.

The protecting unit 3 connects between the power monitoring unit 1 and the storing unit 2, which is utilized for detecting voltage and electric current of each cell 21 and then reacts timely for protecting the cell 21 when the cell 21 is needed to be protected. In other words, the protecting unit 3 is utilized for protecting the cell 21 from over charge, over discharge, over current or over charge current.

The regulator 4 connects between the power monitoring unit 1 and the storing unit 2 and is utilized for DC voltage conversion. Sometimes, voltage from a voltage supplier is larger than a bearing voltage of the power monitoring unit 1 or smaller than a working voltage of the power monitoring unit 1, and therefore, the regulator 4 regulates the voltage from the voltage supplier to a voltage range that the power monitoring unit 1 can work, for example, the voltage from the voltage supplier is 9 to 12V, the working voltage of the power monitoring unit 1 is 5V and then the regulator 4 is needed to regulate 9 to 12V transfer to 5V.

The voltage divider 5 connects between the power monitoring unit 1 and the storing unit 2 and comprises a dividing element 51 and a switch element 52 to form a dividing circuit. The dividing element 51 can be a resistor and the switch element 52 can be complementary metal-oxide semiconductor (CMOS), metal-oxide semiconductor (MOS), field effect transistor (FET) or any switch element made of semiconductor. When voltage of an input signal is larger than the working voltage of the power monitoring unit 1, the voltage divider 5 needs to divide voltage externally in order to let voltage of the input signal within the range of the working voltage of the power monitoring unit 1.

The balancing unit 6 connects between the power monitoring unit 1 and the storing unit 2 and comprises a discharge element 61 connected with a switch element 62. The discharge element 61 can be a resistor, MOS or any element contained impedance and the switch element 62 can be CMOS, MOS, FET or any switch element made of semiconductor. The balancing unit 6 is utilized for discharging electricity from any cell 21 which voltage is higher than that of other cell 21 such that every cell 21 maintains the same voltage to facilitate electricity charge and discharge of battery.

The memory unit 7 may be an electrically erasable programmable read-only memory (EEPROM) and connects with the power monitoring unit 1 for storing data that controls the cell 21.

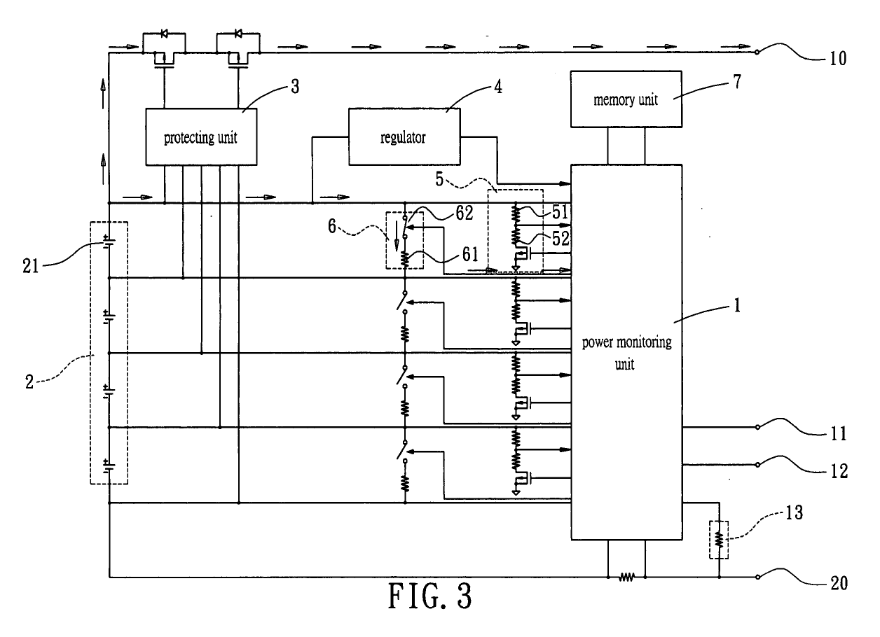

With reference to FIG. 3, the power monitoring and balancing device in accordance with the present invention connects with the electronic device through two connecting points 10, 20 for providing the electric power to the electronic device. At the same time, the two transmitting ends 11, 12 of the power monitoring unit 1 also connect with the electronic device utilized for transmitting measurement results of voltage, electric current and temperature to the electronic device so as to know when the electronic device needs to be recharged, and therefore, it can prevent the electricity of the storing unit 2 from being insufficient to cause data lose.

When the protecting unit 3 detects voltage of any cell 21 of the storing unit 2 lower than the set up voltage (ex 3.6 V), the protecting unit 3 immediately stop power supply provided by the storing unit 2. Then, the ADC of the power monitoring unit 1 detects voltage of each cell 21 and the MCU determines the voltage amount of each cell 21. If the MCU determines the voltage amount (V1) of one cell 21 is higher than that (V2) of the other, the switch element 62 of the balancing unit 6 connected between the cell 21 and the power monitoring unit 1 is to switched on such that the cell 21 is discharging a small amount current toward the discharge element 61 until all cells have same voltage. Thereafter the switching element 62 is switched off such that the cell 21 stop discharging so that every cell 21 maintains at same voltage in order to facilitate charging or discharging of storing unit 2 to fill with or exhaust electric power equally.

Furthermore, the protecting unit 3, regulator 4, voltage divider 5, balancing unit 6 and memory unit 7 can be integrally formed by semiconductor manufacturing technique in order to package with the storing unit 2 together.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A power monitoring and balancing device for a battery provided power to an electronic device, comprising:
a storing unit comprising a plurality of cells;
a power monitoring unit connected with the storing unit, comprising transmitting ends connected to the electronic device; and
a plurality of balancing units respectively connected between the cells and the power monitoring unit,
whereby the power monitoring unit detects and determines each voltage of the cells to switch on a balancing unit that controls a cell with higher voltage than other cells such that the cell is discharged until every cell has same voltage.

2. The power monitoring and balancing device in claim 1, wherein the cells are rechargeable.

3. The power monitoring and balancing device in claim 1, wherein the power monitoring unit comprises at least one micro controller unit and two analog-to-digital converters.

4. The power monitoring and balancing device in claim 1, wherein the balancing unit comprises a discharge element and a switch element connected with the discharge element.

5. The power monitoring and balancing device in claim 4, wherein the discharge element is a resistor, metal-oxide semiconductor (MOS) or an element contained impedance.

6. The power monitoring and balancing device in claim 4, wherein the switch element is a complementary metal-oxide semiconductor (CMOS), metal-oxide semiconductor (MOS), field effect transistor (FET) or a switch element made of semiconductor.

7. The power monitoring and balancing device in claim 1, further comprising a memory unit, a temperature detecting unit and a protecting unit connected between the power monitoring unit and the storing unit.

8. A power monitoring and balancing device for a battery provided power to an electronic device, comprising:
a storing unit comprising a plurality of cells;
a power monitoring unit connected with the storing unit comprising transmitting ends communicating with the electronic device;
a plurality of balancing units respectively connected between the cells and the power monitoring unit; and
a regulator connected between the storing unit and the power monitoring unit,
whereby the power monitoring unit detects and determines each voltage of the cells to switch on a balancing unit that controls a cell with higher voltage than other cells such that the cell is discharged until every cell has same voltage, and the regulator regulates an input voltage receiving by the power monitoring unit within a working voltage range of the power monitoring unit.

9. A power monitoring and balancing device for a battery provided power to an electronic device, comprising:
a storing unit comprising a plurality of cells;
a power monitoring unit connected with the storing unit comprising transmitting ends communicating with the electronic device;
a plurality of balancing units respectively connected between the cells and the power monitoring unit;
a regulator connected between the storing unit and the power monitoring unit; and
a voltage divider connected between the storing unit and the power monitoring unit,
whereby the power monitoring unit detects and determines each voltage of the cells and then switches on a balancing unit that controls a cell with higher than other cells such that the cell is discharged until every cell has same voltage, and the regulator and the voltage divider respectively regulate and divide an input voltage receiving by the power monitoring unit within a working voltage range of the power monitoring unit.

10. The power monitoring and balancing device in claim 9, wherein the voltage divider includes a dividing element and a switch element to form a dividing circuit.

11. The power monitoring and balancing device in claim 10, wherein the switch element is a complementary metal-oxide semiconductor (CMOS), metal-oxide semiconductor (MOS), field effect transistor (FET) or a switch element made of semiconductor.
